(19) United States
(12) Patent Application Publication
(10) Pub. No.: US 2021/0179067 A1
(43) Pub. Date: Jun. 17, 2021

(54) APPARATUS AND METHOD OF CONTROLLING HYBRID VEHICLE HAVING ELECTRIC SUPERCHARGER

(71) Applicants: HYUNDAI MOTOR COMPANY, Seoul (KR); KIA MOTORS CORPORATION, Seoul (KR)

(72) Inventors: Yong Kak CHOI, Seoul (KR); Hyun Woo LIM, Hwaseong-si (KR); Buhm Joo SUH, Hwaseong-si (KR); Jinkuk CHO, Hwaseong-si (KR); Kwanhee LEE, Suwon-si (KR); Sungchan NA, Seongnam-si (KR); Yeongseop PARK, Seoul (KR); Jihyun PARK, Hwaseong-si (KR); Seungwoo HONG, Seoul (KR); Dong Hee HAN, Seongnam-si (KR); Hyunjin KANG, Hwaseong-si (KR)

(73) Assignees: HYUNDAI MOTOR COMPANY, Seoul (KR); KIA MOTORS CORPORATION, Seoul (KR)

(21) Appl. No.: 16/895,403

(22) Filed: Jun. 8, 2020

(30) Foreign Application Priority Data
Dec. 11, 2019 (KR) 10-2019-0164441

(51) Int. Cl. B60W 20/15; F02M 35/10; B60W 20/13; F02B 39/10; B60W 10/06; B60W 10/08; B60W 10/30; B60K 6/24; B60K 6/26; B60K 6/38; B60K 6/28; B60K 6/46

(52) U.S. Cl. CPC B60W 20/15; B60Y 2300/188; B60W 20/13; F02M 35/10157; F02B 39/10; B60W 10/06; B60W 10/08; B60W 10/30; B60K 6/24; B60K 6/26; B60K 6/38; B60K 6/28; B60K 6/46; B60W 2540/10; B60W 2510/244; B60W 2510/305; B60Y 2200/92; F02M 35/10242

(57) ABSTRACT

An apparatus of controlling a hybrid vehicle may include: an engine configured to an engine power; a drive motor to assist the power of the engine and selectively operate as a generator to generate electrical energy; a clutch disposed between the engine and the drive motor; a battery to supply electrical energy to the drive motor or to be charged by the electrical energy generated by the drive motor; an electric supercharger installed in an intake line through which an ambient air is supplied to a combustion chamber of the engine; and a controller to operate the electric supercharger and control the engine power output from the engine and a drive motor power output from the drive motor based on a desired power of a driver and a SOC (state of charge) of the battery.

### CROSS-REFERENCE TO RELATED APPLICATION

This application claims priority to and the benefit of Korean Patent Application No. 10-2019-0164441, filed on Dec. 11, 2019, the entire contents of which are incorporated herein by reference.

### FIELD

The present disclosure relates to an apparatus and a method of controlling a hybrid vehicle having an electric supercharger. More particularly, the present disclosure relates to an apparatus and a method of controlling a power distribution of an engine and a drive motor in a hybrid vehicle with an electric supercharger.

### BACKGROUND

The statements in this section merely provide background information related to the present disclosure and may not constitute prior art.

A hybrid vehicle is a vehicle using two or more kinds of power sources, and generally refers to a hybrid electric vehicle driven by using an engine and a motor. The hybrid electric vehicle may form various structures by using two or more kinds of power sources including an engine and a motor.

In general, the hybrid electric vehicle adopts a powertrain in a scheme of a Transmission Mounted Electric Device (TMED) in which a driving motor, a transmission, and a driving shaft are serially connected.

Further, a clutch is provided between the engine and the motor, so that the hybrid electric vehicle is operated in an Electric Vehicle (EV) mode, a Hybrid Electric Vehicle (HEV) mode, or an engine single mode according to the coupling of the clutch. The EV mode is the mode in which the vehicle travels only with driving power of the driving motor, and the HEV mode is the mode in which the vehicle travels with driving power of the driving motor and the engine.

In the hybrid vehicle, it is very important to manage a state of charge (SOC) which indicates a charge amount of a battery to supply electric power to a drive motor and electric components provided in the vehicle.

When the SOC is low and the driving load of the vehicle is high, the vehicle travels by only the engine's output without assistance of the drive motor. For example, the vehicle travels in very high speed, the vehicle continuously travels in long uphill road, or the vehicle travels in high-level road. In this case, the fuel efficiency and exhaust gas are deteriorated due to the engine's excessive output and high engine speed.

The above information disclosed in this Background section is only for enhancement of understanding of the background of the present disclosure, and therefore it may contain information that does not form the prior art that is already known to a person of ordinary skill in the art.

### SUMMARY

The present disclosure provides an apparatus and a method of controlling a hybrid vehicle provided with an electric supercharger that can improve a driving performance and efficiently manage a SOC (state of charge) of a battery when a high driving load is desired in a low SOC state.

In one form of the present disclosure, an apparatus of controlling a hybrid vehicle may include: an engine configured to generate an engine power by combustion of fuel; a drive motor configured to generate a power to assist the engine power of the engine and selectively operate as a generator to generate electrical energy; a clutch configured to disposed between the engine and the drive motor; a battery configured to supply electrical energy to the drive motor or to be charged with the electrical energy generated by the drive motor; an electric supercharger installed in an intake line through which an ambient air flows to be supplied to a combustion chamber of the engine; and a controller configured to operate the electric supercharger and control the engine power output from the engine and the drive motor power output from the drive motor based on a desired power of a driver and a SOC (state of charge) of the battery.

The desired power may be determined from a position of an accelerator pedal position sensor (APS) operated by the driver, and in one form, based on the desired power, a desired operation of the hybrid vehicle is divided into a maximal high load state, a high load state, a middle load state, and a low load state.

In one form, when the desired operation is the maximal high load state and the SOC of the battery is greater than a predetermined value, the controller may control the engine to output a maximal power, operate the electric supercharger so that the engine outputs the maximal power, and control the drive motor to output a remained power corresponding to a power gap between the maximal power of the engine and a target driving power of the vehicle which is determined based on the desired power. The controller may control the battery to supply the electrical energy to the drive motor, where the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner.

In some forms of the present disclosure, when the desired operation is the maximal high load state and the SOC of the battery is less than a predetermined value, the controller may operate the electric supercharger to cause the engine to output the maximal power and control the drive motor to be operated as a generator that generates electrical energy by using a part of the maximal power output from the engine, and the generated electrical energy by the drive motor is supplied to the electric supercharger, electric components, and an air conditioner of the hybrid vehicle.

In some form, when the desired operation is the high load state and the SOC of the battery is greater than a predetermined value, the controller may control the engine to output a maximal power, operate the electric supercharger so the engine outputs the maximal power, and control the drive motor to output a remained power corresponding to a power gap between the maximal power of the engine and the target driving power of the vehicle. The controller may control the battery to supply the electrical energy to the drive motor, where the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner.

When the desired operation is the high load state and the SOC of the battery is less than a predetermined value, the controller may control the engine to output a maximal power, operate the electric supercharger so that the engine outputs the maximal power, and control the drive motor to be operated as a generator that generates electrical energy by using a part of the maximal power output from the engine. The generated electrical energy by the drive motor is supplied to the electric supercharger, electric components, and an air conditioner.

When the desired operation is the middle load state and the SOC of the battery is greater than a predetermined value, the controller may control the engine to output an optimal power to be operated in an optimal efficiency point, operate the electric supercharger so that the engine outputs the optimal power, and control the drive motor to output a remained power corresponding to a power gap between the optimal power of the engine and the target driving power of the vehicle. The controller may control the battery to supply the electrical energy to the drive motor, where the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner.

When the desired operation is the middle load state and the SOC of the battery is less than a predetermined value, the controller may control the engine to output an optimal power to be operated in in an optimal efficiency point, operate the electric supercharger so that the engine outputs the optimal power, and control the drive motor to be operated as a generator that generates a summation power and a charging power by using the optimal power output from the engine. In one form, the summation power may be a power that sums a supercharger power to be consumed by the electric supercharger, an electric component power to be consumed by electric components, and an air conditioner power to be consumed by an air conditioner, and the charging power is a power for charging the battery.

The controller may control the engine to output an optimal power to be operated in an optimal efficiency point, stop an operation of the electric supercharger, and control the drive motor to output a remained power corresponding to a power gap between the optimal power of the engine and the target driving power of the vehicle when the desired operation is the low load state and the SOC of the battery is greater than a predetermined value. In particular, the remained power is calculated by subtracting, from a battery power determined by the SOC of the battery, a sum of a supercharger power consumed by the electric supercharger, an electric component power consumed by electric components, and an air conditioner power consumed by an air conditioner of the hybrid vehicle, and the target driving power may be output by summing the optimal power of the engine and a drive motor power output from the drive motor.

The controller may control the engine to output an optimal power to be operated in an optimal efficiency point, and stop an operation of the electric supercharger and controls the drive motor as a generator to generate a summation power and a charging power to charger the battery by using a part of the optimal power output from the engine when the desired operation is the low load state and the SOC of the battery is less than a predetermined value, wherein the summation power may be a power that sums an electric component power consumed by electric components and an air conditioner power consumed by an air conditioner.

In another form, the present disclosure provides, a method of controlling a hybrid vehicle including a drive motor and an engine a driving power for travelling the vehicle and an electric supercharger installed in an intake line. The method may include: determining, by a controller, a desired power of a driver based on a pressing amount of an accelerator pedal; and operating, by the controller, the electric supercharger and controlling an engine power output from the engine and a drive motor power output from the drive motor based on the desired power and a state of charge (SOC) of a battery.

The desired power may be determined from a position of an accelerator pedal position sensor (APS) disposed in the vehicle, and a desired operation of the hybrid vehicle is determined by the controller based on the desired power and divided into a maximal high load state, a high load state, a middle load state, and a low load state.

When the desired operation is the maximal high load state and the SOC of the battery is greater than a predetermined value, controlling the engine to output a maximal power; operating the electric supercharger so that the engine outputs the maximal power; controlling the drive motor to output a remained power corresponding to a power gap between the maximal power of the engine and a target driving power of the vehicle which is determined based on the desired power. In particular; and controlling, by the controller, the battery to supply electrical energy to the drive motor. In particular, the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner.

When the desired operation is the maximal high load state and the SOC of the battery is less than a predetermined value, controlling the engine to output a maximal power; operating the electric supercharger so that the engine outputs the maximal power; and controlling the drive motor to be operated as a generator that generates a summation power by using a part of the maximal power output from the engine, wherein the summation power may be a power that sums a supercharger power consumed by the electric supercharger, an electric component power consumed by electric components, and an air conditioner power consumed by an air conditioner.

When the desired operation is the high load state and the SOC of the battery is greater than a predetermined value, controlling the engine to output a maximal power; operating the electric supercharger so that the engine outputs the maximal power; and controlling the drive motor to output a remained power corresponding to a power gap between the maximal power of the engine and the target driving power of the vehicle, and wherein the remained power is calculated by subtracting a summation power from a battery power in which the battery can output may be supplied to the drive motor, and the driving power is output by summing the maximal power of the engine and a drive motor power output from the drive motor, wherein the summation power may be a power that sums a supercharger power consumed by the electric supercharger, an electric component power consumed by electric components, and an air conditioner power consumed by an air conditioner.

When the desired operation is the high load state and the SOC of the battery is less than a predetermined value, controlling the engine to output a maximal power; operating the electric supercharger so that the engine outputs the maximal power; and controlling the drive motor to be operated as a generator that generates a summation power by using a part of the maximal power output from the engine, and wherein the summation power may be a power that sums a supercharger power consumed by the electric supercharger, an electric component power consumed by electric components, and an air conditioner power consumed by an air conditioner.

When the desired operation is the middle load state and the SOC of the battery is greater than a predetermined value, controlling the engine to output an optimal power; operating the electric supercharger so that the engine outputs the optimal power; and controlling the drive motor to output a remained power which is a power gap between the optimal power of the engine and the target driving power of the vehicle, wherein a residual power excluding a summation power from a battery power in which the battery can output may be supplied to the drive motor, and the driving power is output by summing the optimal power of the engine and a drive motor power output from the drive motor, and wherein the summation power is a power that sums a supercharger power consumed by the electric supercharger, an electric component power consumed by electric components, and an air conditioner power consumed by an air conditioner.

When the desired operation is the middle load state and the SOC of the battery is less than a predetermined value, controlling the engine to output an optimal power; and operating the electric supercharger so that the engine outputs the optimal power; and controlling the drive motor to be operated as a generator that generates a summation power and a charging power by using the optimal power output from the engine, wherein the summation power may be a power that sums a supercharger power consumed by the electric supercharger, an electric component power consumed by electric components, and an air conditioner power consumed by an air conditioner, and the charging power is a power for charging the battery.

When the desired operation is the low load state and the SOC of the battery is greater than a predetermined value, controlling the engine to output an optimal power; stopping an operation of the electric supercharger; and controlling the drive motor to output a remained power excluding the optimal power of the engine from the driving power of the vehicle, wherein a residual power excluding a summation power from a battery power in which the battery can output may be supplied to the drive motor, and the driving power may be output by summing the optimal power of the engine and a drive motor power output from the drive motor, and wherein the summation power may be a power that sums a supercharger power consumed by the electric supercharger, an electric component power consumed by electric components, and an air conditioner power consumed by an air conditioner.

When the desired operation is the low load state and a SOC of the battery is less than a predetermined value, controlling the engine to output an optimal power; stopping an operation of the electric supercharger; and controlling the drive motor to be operated as a generator to generate a summation power and a charging power to charger the battery by using a part of the optimal power output from the engine, wherein the summation power may be a power that sums an electric component power consumed by electric components and an air conditioner power consumed by an air conditioner.

According to an exemplary form of the present disclosure, a power distributing method is provided according to SOC of the battery, thereby improving fuel efficiency in a driving state of a high load condition.

In addition, since additional decrement of the SOC can be prevented when the vehicle travels with only the engine output in a situation where the SOC is low, thereby improving a driving performance of the vehicle.

Further, since it is easy to prevent the SOC from falling when compared to the case where a natural aspiration (NA) engine is applied to the hybrid vehicle, it is possible to reduce manufacturing cost by reducing battery capacity.

In addition, it is possible to prevent the engine from being used in a high RPM region compared to when the NA engine is applied to the hybrid vehicle, thereby suppressing noise and vibration generated in the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a conceptual diagram illustrating a configuration of an apparatus for controlling a hybrid vehicle according to an exemplary form of the present disclosure;

FIG. 2 is a conceptual diagram illustrating a relationship between an engine and an electric supercharger of the hybrid vehicle according to an exemplary form of the present disclosure;

FIG. 3 is a block diagram illustrating the configuration of the apparatus for controlling the hybrid vehicle according to an exemplary form of the present disclosure;

FIG. 4 is a diagram illustrating a State of Charge (SOC) region of a battery according to an exemplary form of the present disclosure;

FIG. 5 and FIG. 6 are diagrams for explaining a process of a power distribution of an engine and a drive motor in a maximal high load state;

FIG. 7 and FIG. 8 are diagrams for explaining a process of a power distribution of an engine and a drive motor in a high load state;

FIG. 9 and FIG. 10 are diagrams for explaining a process of a power distribution of an engine and a drive motor in a middle load state; and

FIG. 11 to FIG. 13 are diagrams for explaining a process of a power distribution of an engine and a drive motor in a low load state.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described forms may be modified in various different ways, all without departing from the spirit or scope of the present disclosure.

In addition, the size and thickness of each configuration shown in the drawings are arbitrarily shown for understanding and ease of description, but the present disclosure is not limited thereto, and for clearly illustrate several portions and regions, thicknesses thereof are increased.

Hereinafter, an apparatus for controlling a hybrid vehicle according to an exemplary form of the present disclosure will be described in detail with reference to the accompanying drawings.

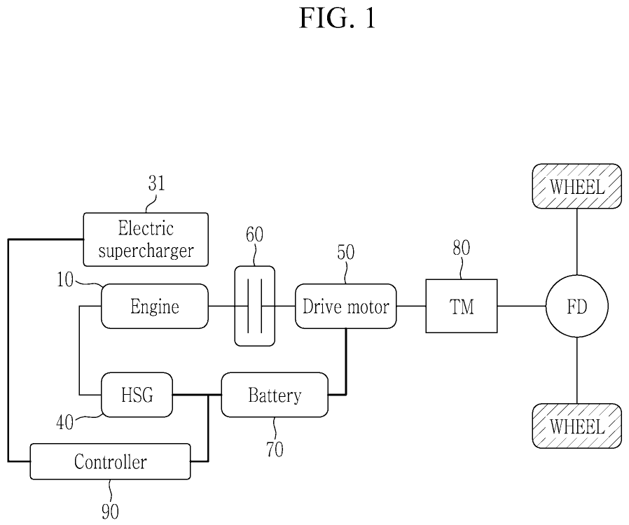

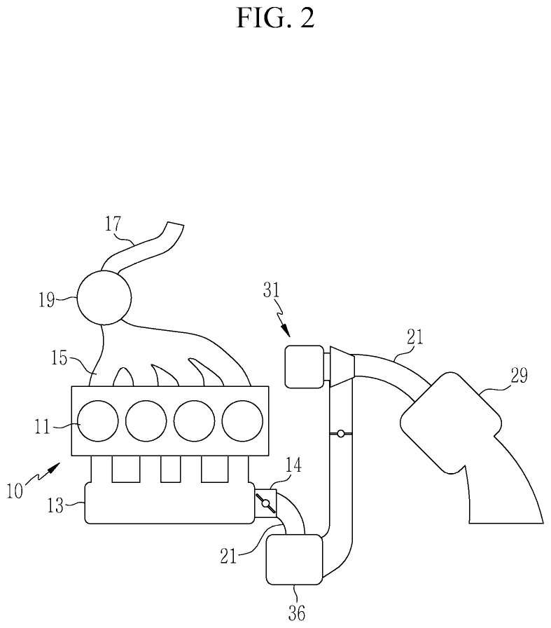

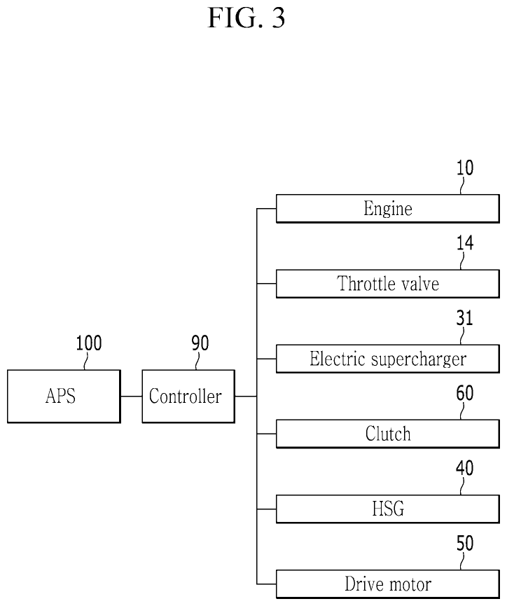

FIG. 1 is a conceptual diagram illustrating a configuration of an apparatus for controlling a hybrid vehicle according to an exemplary form of the present disclosure. FIG. 2 is a conceptual diagram illustrating a relationship between an engine and an electric supercharger of the hybrid vehicle in one form of the present disclosure. FIG. 3 is a block diagram illustrating the configuration of the apparatus for controlling the hybrid vehicle according to an exemplary form of the present disclosure.

The hybrid vehicle according to the exemplary form of the present disclosure described below will be described based on a structure of a Transmission Mounted Electric Device (TMED) scheme as an example. However, the scope of the present disclosure is not limited thereto, and the present disclosure may be applied to hybrid electric vehicles in other schemes as a matter of course.

As shown FIG. 1 to in FIG. 3, a hybrid vehicle to which the apparatus for controlling the hybrid vehicle is applied may include an engine 10, a HSG 40, a driving motor 50, a clutch 60, a battery 70, an electric supercharger 31, an acceleration pedal sensor, and a controller 90.

The engine 10 generates the power desired to drive the vehicle by combustion of fuel.

Referring to FIG. 2, the intake air supplied to the combustion chamber 11 of the engine 10 is supplied through the plurality of intake lines, and exhaust gas discharged from the combustion chamber 11 of the engine 10 is discharged to the outside through an exhaust manifold 15 and an exhaust line 17. In this case, a catalyst converter 19 including a catalyst which purifies exhaust gas is installed in the exhaust line 17.

The electric supercharger 31 is installed in the intake line 20 in order to supply supercharged air to the combustion chamber 11, and includes a motor and an electric compressor. The electric compressor is operated by the motor and compresses outside air according to an operation condition and supplies the compressed outside air to the combustion chamber 11.

An intercooler may be installed in the intake line. The air compressed by the electric supercharger 31 is cooled by the intercooler.

An air cleaner 29 for filtering outside air introduced from the outside is mounted in an entrance of the intake line 20.

Intake air introduced through the intake line 20 is supplied to the combustion chamber 11 through the intake manifold 13. A throttle valve 14 is mounted to the intake manifold 13 and adjusts the amount of air supplied to the combustion chamber 11.

Referring back to FIG. 1, the HSG 40 starts the engine 10 and selectively operates as a power generator in the state where the engine 10 starts to generate electric energy.

The driving motor 50 assists power of the engine 10 and selectively operates as a power generator to generate electric energy.

The driving motor 50 is operated by using electric energy charged in the battery 70, and the electric energy generated in the driving motor 50 and the HSG 40 is charged in the battery 70.

In the hybrid vehicle according to an exemplary form of the present disclosure, an engine power and a driving motor power are distributed base on the SOC (state of charge) of the battery. The SOC of the battery 70 may generally be divided into three regions according to an exemplary form of the present disclosure

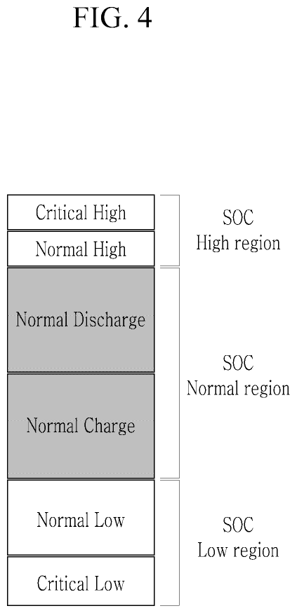

Referring to FIG. 4, the SOC region of the battery 70 may be divided into a high region, a normal region, and a low region according to the charging amount of the battery 70. Further, according to the charging amount of the battery 70, the high region may be divided into a Critical High (CH) region and a Normal High (NH) region, the normal region may be divided into a normal discharge (ND) region and a normal charge (NC) region, and the low region may be divided into a normal low (NL) region and a critical low (CL) region.

The acceleration pedal sensor (APS) detects an operation of an acceleration pedal. The accelerator pedal position detected by the accelerator pedal sensor is transmitted to the controller 90. The controller 90 may determine a desired power based on the accelerator pedal position detected by the accelerator pedal sensor, and selectively switch the travelling mode of the vehicle to the EV mode and the HEV mode.

The controller 90 controls the constituent elements of the vehicle including the engine 10, the HSG 40, the driving motor 50, the electric supercharger 31, the battery 70, and the clutch 60.

In one form, the controller 90 may be provided as one or more processors operated by a set program, and the set program may perform each operation of a method of controlling a hybrid vehicle according to an exemplary form of the present disclosure.

The clutch 60 is provided between the engine 10 and the driving motor 50, and the hybrid vehicle is operated in the electric vehicle (EV) mode, or the hybrid electric vehicle (HEV) mode according to the coupling of the clutch 60. The EV mode is the mode in which the vehicle travels only with driving power of the motor, and the HEV mode is the mode in which the vehicle travels with driving power of the motor and the engine 10.

Driving power output from the engine 10 and the driving motor 50 is transferred to the driving wheels provided in the vehicle. In this case, a transmission 80 is provided between the clutch 60 and the driving wheels. A shifting gear is installed inside the transmission 80, so that torque output from the engine 10 and the driving motor 50 is changed according to a shifting gear stage.

Hereinafter, a method of controlling a hybrid vehicle according to an exemplary form of the present disclosure will be described in detail with reference to the accompanying drawings.

The controller may determine an acceleration intention of a driver (or, a desired power of the driver) based on a pressing amount (or, position) of the accelerator pedal. The desired power of the driver (i.e., the desired operation of the hybrid vehicle) may be divided into a maximal high load state, a high load state, a middle load state, and a low load state according to the pressing amount of the accelerator pedal.

For example, when the pressing amount of the accelerator pedal is 100%, the desired operation may be the maximal high load state (e.g., WOT: wide open throttle). When the pressing amount of the accelerator pedal is less than 100% and greater than 60%, the desired operation may be the high load state (e.g., HTI: high tip-in). When the pressing amount of the accelerator pedal is less than 60% and greater than 30%, the desired operation may be the middle load state (e.g., MTI: middle tip-in). When the pressing amount of the accelerator pedal is less than 30% and greater than 0%, the desired operation may be the low load state (e.g., LTI: low tip-in). When the pressing amount of the accelerator pedal is 0% and the pressing amount of the brake pedal is 0%, it is possible to determine that the vehicle travels in coasting. Finally, when the pressing amount of the accelerator pedal is 0% and the brake pedal is pressed, it is possible to determine that the vehicle is in braking.

The controller may calculate a driving load of the vehicle according to the desired power of the driver from the pressing amount of the accelerator pedal. The driving load of the vehicle may be calculated based on the desired power of the driver, a current vehicle speed, and an inclined degree of a vehicle body.

When the desired operation of the driver is the maximal high load state (WOT: wide open throttle) and the SOC of the battery is greater than a predetermined value (it may mean all regions except the low region in an exemplary form of the present disclosure), the controller may calculate a target driving power based on the desired power of the driver. And the controller controls the engine to output maximal power, and operates the electric supercharger so that the engine outputs maximal power. At this time, the rotation speed of the electric supercharger is determined so that the engine outputs maximal torque corresponding to an engine speed. And the controller calculates the power of the electric supercharger for the engine to output maximal power.

In the maximal high load state, a remained power excluding the maximal power of the engine from the driving power of the vehicle is output through the drive motor. For this, the controller calculates a summation power that sums a supercharger power consumed by the electric supercharger, an electric component power consumed by electric components, and an air conditioner power consumed by an air conditioner. And a residual power excluding the summation power from the battery power in which the battery can output is supplied to the drive motor, and the controller controls the drive motor to output a remained power excluding the maximal power of the engine from the driving power.

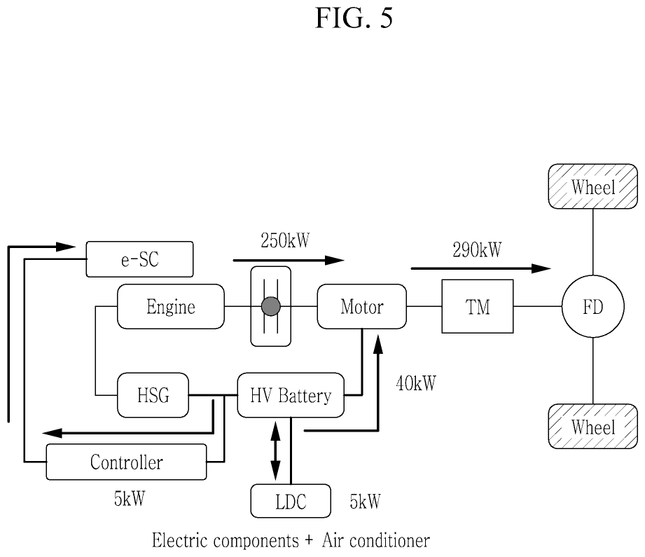

For example, referring to FIG. 5, when the driving power of the vehicle is 290 kw, the controller operates the electric supercharger so that the engine outputs the maximal power of 250 kw. Assume that the supercharger power consumed by the electric supercharger is 10 kw, and the electric component power and the air conditioner power are 5 kw. Thus, the summation power becomes 15 kw. In this case, the controller controls the battery to output the summation power of 15 kw to the electric supercharger, the electric component, and the air conditioner, and controls the drive motor to output the remained power of 40 kw excluding the maximal power of the engine of 250 kw from the driving power of 290 kw

When the desired operation of the driver is the maximal high load state (WOT: wide open throttle) and the SOC of the battery is less than a predetermined value (it may means the low region of SOC in an exemplary form of the present disclosure), the controller calculates the target driving power based on the desired power of the driver. And the controller controls the engine to output an engine maximal power, and operates the electric supercharger so that the engine outputs the maximal power. At this time, the rotation speed of the electric supercharger is determined so that the engine outputs a maximal torque corresponding to an engine speed. And the controller calculates the power of the electric supercharger for the engine to output the maximal power.

The controller calculates the summation power that sums a supercharger power consumed by the electric supercharger, an electric component power consumed by electric components, and an air conditioner power consumed by an air conditioner.

In this case, since the SOC is a low state, the summation power for operating the electric supercharger, the electric component, and the air conditioner uses a part of the power output from the engine. That is, the controller operates the drive motor as a generator to generate the summation power by using a part of the maximal power output from the engine.

Accordingly, the power excluding the summation power from the maximal power of the engine is output as the driving power of the vehicle.

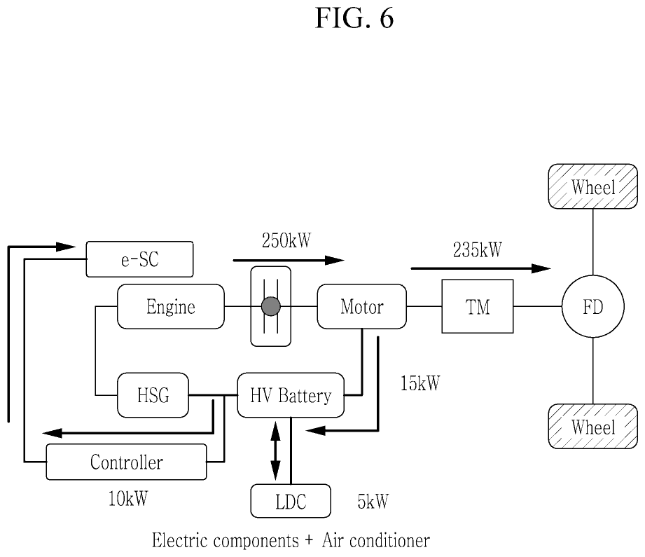

For example, referring to FIG. 6, when the maximal power output from the engine is 250 kw, the controller operates the electric supercharger so that the engine outputs the maximal power of 250 kw. Assume that the supercharger power is 10 kw, and the electric component power and the air conditioner power are 5 kw. Thus, the summation power becomes 15 kw. In this case, the controller operates the drive motor as a generator to generate 15 kw among the maximal power output from the engine and supplied it to the electric supercharger, the electric component and the air conditioner. And 235 kw, excluding the summation power 15 kw from the engine's maximal power 250 kw, is output as the driving power.

As such, since some of the maximal power of the engine is used as power desired to operate the electric supercharger, the electric component, and the air conditioner in the low region of the SOC and the maximal high load state, it is possible to prevent the SOC of the battery from entering the critical low region.

When the vehicle is in a stop state, the desired operation of the driver is the maximal high load state (WOT: wide open throttle), and the battery is in an extreme condition (e.g., the SOC of the battery is in the critical low region, or temperature of the battery is very high or very low in an exemplary form of the present disclosure), the controller calculates the target driving power based on the desired power of the driver. And the controller controls the engine to output the maximal power, and operates the HSG as a generator to charge, using some of the engine's maximal power, the battery in a state where the operation of the electric supercharger is stopped.

When the SOC is very low, and the vehicle is stopped or the vehicle speed is very slow (e.g., the vehicle speed is under 10 kph), the speed of the drive motor is lowered to drive the vehicle. At this time, though the speed of the driver motor is very slow (e.g., under 1000 rpm), the engine speed is relatively faster (e.g., over 1000 rpm). In this case, because the difference between the speed of the drive motor and the engine speed is large, the clutch cannot be engaged, so some of the power of the engine is charged to the battery through HSG.

The controller calculates the summation power that sums the electric component power, and the air conditioner power.

In this case, since the SOC of the battery is very low, the electric component power and the air conditioner power uses a power charged in the battery through the HSG. And the remained power excluding the electric component power and the air conditioner power from the charged power in the battery is supplied to the electric supercharger.

When the electric supercharger starts to operate, the maximal power that is output from the engine is gradually increased, and the power amount generated through HSG is also increased. Accordingly, the power supplied to the electric supercharger gradually is increased.

When the speed of the drive motor increases as the vehicle speed gradually increases (e.g., more than 10 kph), the engine speed and the speed of the drive motor can be synchronized, so the power output from the engine may be generated through the drive motor by engaging the clutch.

When the desired operation of the driver is the high load state (HTI: high tip-in) and the SOC of the battery is greater than a predetermined value (it may mean all regions except the low region in an exemplary form of the present disclosure), the controller controls the engine to output an optimal power to be operated in an optimal efficiency point and operates the electric supercharger so that the engine outputs the optimal power. At this time, the rotation speed of the electric supercharger is determined so that the engine outputs optimal torque corresponding to an engine speed. And the controller calculates the power of the electric supercharger for the engine to output the optimal power.

In the high load state, a remained power excluding the optimal power of the engine from the driving power of the vehicle is output through the drive motor. For this, the controller calculates a summation power that sums a supercharger power consumed by the electric supercharger, an electric component power consumed by electric components, and an air conditioner power consumed by an air conditioner. And a residual power excluding the summation power from the battery power in which the battery can output is supplied to the drive motor, and the controller controls the drive motor to output a remained power excluding the optimal power of the engine from the driving power.

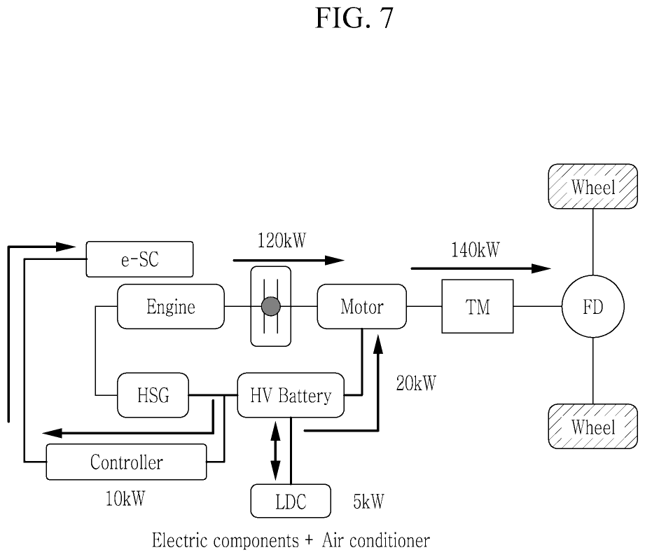

For example, referring to FIG. 7, when the driving power of the vehicle is 140 kw, the controller operates to electric supercharger so that the engine outputs the optimal power of 120 kw. Assume that the supercharger power is 10 kw, and the electric component power and the air conditioner power are 5 kw. Thus, the summation power becomes 15 kw. In this case, the controller controls the battery to output the summation power of 15 kw to the electric supercharger, the electric component, and the air conditioner, and controls the drive motor to output the remained power of 20 kw excluding the engine's optimal power of 120 kw from the driving power of 140 kw.

When the desired operation of the driver is the high load state (HTI: high tip-in) and the SOC of the battery is less than a predetermined value (it may means the low region of SOC in an exemplary form of the present disclosure), the controller calculates the target driving power based on the desired power of the driver. And the controller controls the engine to output an optimal power and operates the electric supercharger so that the engine outputs the optimal power. At this time, the rotation speed of the electric supercharger is determined so that the engine outputs optimal torque corresponding to an engine speed. And the controller calculates the power of the electric supercharger for the engine to output the optimal power.

The controller calculates the summation power that sums the supercharger power, the electric component power, and the air conditioner power.

In this case, since the SOC is a low state, the summation power for operating the electric supercharger, the electric component, and the air conditioner uses a part of the power output from the engine. That is, the controller operates the drive motor as a generator to generate the summation power by using a part of the optimal power output from the engine.

Accordingly, the power excluding the summation power from the optimal power of the engine is output as the driving power of the vehicle.

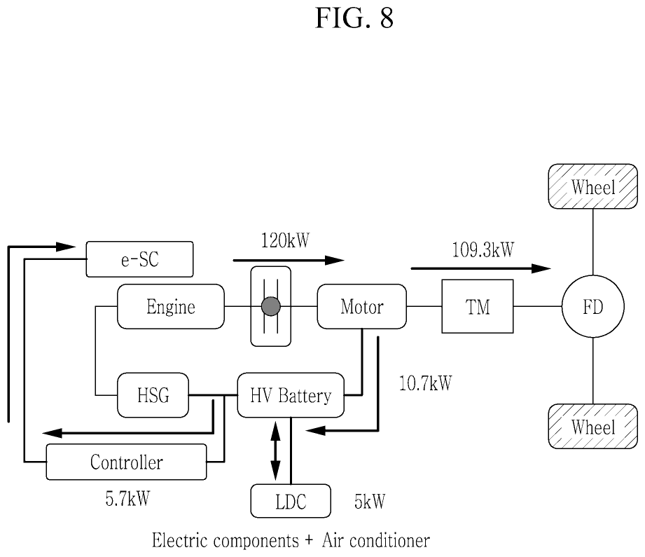

For example, referring to FIG. 8, when the optimal power output from the engine is 120 kw, the controller operates the electric supercharger so that the engine outputs the optimal power of 120 kw. Assume that the supercharger power is 5.7 kw, and the electric component power and the air conditioner power are 5 kw. Thus, the summation power becomes 10.7 kw. In this case, the controller operates the drive motor as a generator to generate 10.7 kw among the optimal power output from the engine and supplied it to the electric supercharger, the electric component and the air conditioner. And 109.3 kw, excluding the summation power 10.7 kw from the engine's optimal power 120 kw, is output as the driving power.

As such, since some of the optimal power of the engine is used as power desired to operate the electric supercharger, the electric component, and the air conditioner in the low region of the SOC and the maximal high load state, it is possible to prevent the SOC of the battery from entering the critical low region.

When the desired operation of the driver is the middle load state (MTI: middle tip-in) and the SOC of the battery is greater than a predetermined value, the controller calculates the target driving power based on the desired power of the driver. And the controller controls the engine to output an optimal power to be operated in an optimal efficiency point and operates the electric supercharger so that the engine outputs the optimal power. At this time, the rotation speed of the electric supercharger is determined so that the engine outputs optimal torque corresponding to an engine speed. And the controller calculates the power of the electric supercharger for the engine to output the optimal power.

In the middle load state, a remained power corresponding to a power gap between the optimal power of the engine and the target driving power of the vehicle is output through the drive motor. For this, the controller calculates a summation power that sums a supercharger power consumed by the electric supercharger, an electric component power consumed by electric components, and an air conditioner power consumed by an air conditioner. And a residual power excluding the summation power from the battery power in which the battery can output is supplied to the drive motor, and the controller controls the drive motor to output the remained power (i.e., a power subtracting the optimal power of the engine from the target driving power).

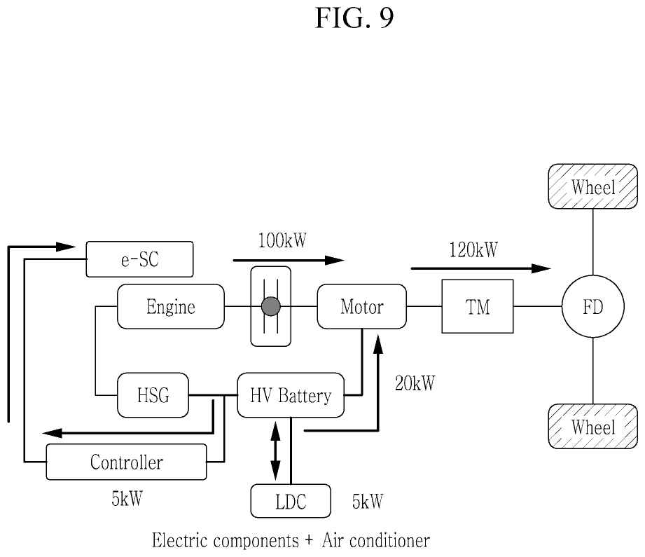

For example, referring to FIG. 9, when the target driving power of the vehicle is 120 kw, the controller operates the electric supercharger so that the engine outputs the optimal power of 100 kw. Assume that the supercharger power is 5 kw, and electric component power and the air conditioner power are 5 kw. Thus, the summation power becomes 10 kw. In this case, the controller controls the battery to output summation power of 10 kw to the electric supercharger, the electric component, and the air conditioner, and controls the drive motor to output the remained power of 20 kw (i.e., the power gap between the engine's optimal power of 100 kw and the target driving power of 120 kw).

When the desired operation of the driver is the middle load state (MTI: middle tip-in) and the SOC of the battery is less than a predetermined value (it may means the low region of SOC in an exemplary form of the present disclosure), the controller calculates the target driving power based on the desired power of the driver. And the controller controls the engine to output an optimal power and operates the electric supercharger so that the engine outputs the optimal power. At this time, the rotation speed of the electric supercharger is determined so that the engine outputs optimal torque corresponding to an engine speed. And the controller calculates the power of the electric supercharger for the engine to output the optimal power.

The controller calculates the summation power that sums the supercharger power, the electric component power, and the air conditioner power.

In this case, since the SOC is a low state, the summation power for operating the electric supercharger, the electric component, and the air conditioner uses a part of the power output from the engine. That is, the controller operates the drive motor as a generator to generate the summation power and a charging power to charger the battery by using a part of the optimal power output from the engine.

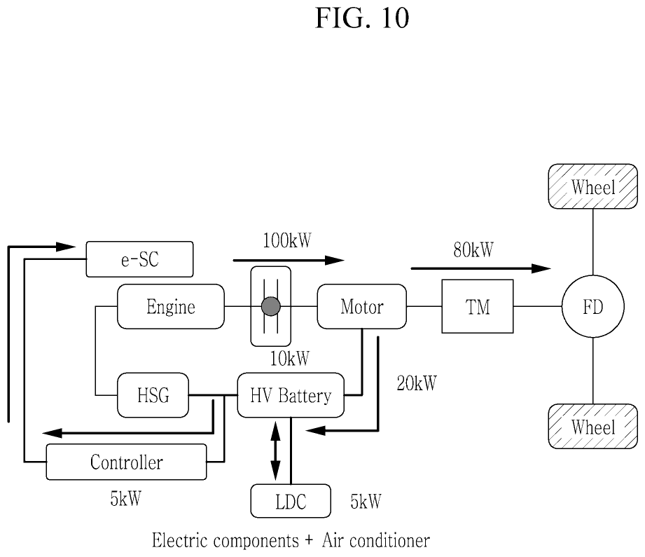

For example, referring to FIG. 10, when the optimal power output from the engine is 100 kw, the controller operates the electric supercharger so that the engine outputs the optimal power of 100 kw. Assume that the supercharger power is 5 kw, and the electric component power and the air conditioner power are 5 kw. Thus, the summation power becomes 10 kw. In this case, the controller operates the drive motor as a generator to generate 10 kw using the optimal power output from the engine and supplied it to the electric supercharger, the electric component and the air conditioner. And the charging power of 10 kw for charging the battery is charged in the battery. Accordingly, 80 kw, excluding the summation power of 10 kw and the charging power of 10 kw from the engine's optimal power 100 kw, is output as the driving power.

As such, in the SOC is in the low region and the middle load state, some of the optimal power of the engine is used as power desired to operate the electric supercharger, the electric component, and the air conditioner, and some of the optimal power of the engine is used to charge the battery.

When the desired operation of the driver is the low load state (LTI: low tip-in) and the SOC of the battery is greater than a predetermined value, and the travelling mode of the vehicle may be determined as HEV mode or EV mode. At this time the travelling mode of the vehicle may be determined according to the pressing amount of the accelerator pedal and the SOC of the battery. For example, the vehicle may travel in EV mode when the SOC is in the high region, and the vehicle may travel in HEV mode when the SOC is in the normal region.

When the travelling mode of the vehicle is the HEV mode, the controller calculates the target driving power based on the desired power of the driver. And the controller controls the engine to output an optimal power to be operated in an optimal efficiency point and the electric supercharger do not operated.

In the low load state, a remained power corresponding to a power gap between the optimal power of the engine and the target driving power of the vehicle is output through the drive motor. For this, the controller calculates a summation power that sums an electric component power consumed by electric components and an air conditioner power consumed by an air conditioner. And the residual power excluding the summation power from the battery power in which the battery can output is supplied to the drive motor, and the controller controls the drive motor to output the remained power, (i.e., the power gap between the optimal power of the engine and the target driving power).

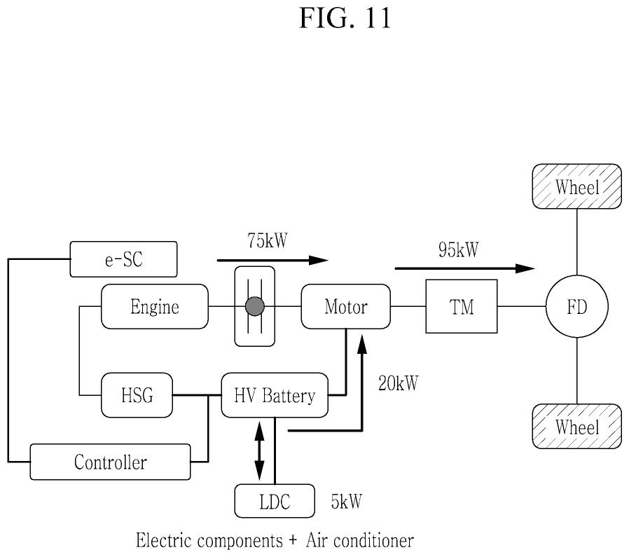

For example, referring to FIG. 11, when the target driving power of the vehicle is 95 kw, the controller operates to electric supercharger so that the engine outputs the optimal power of 75 kw. Assume that the electric component power and the air conditioner power are 5 kw. Thus, the summation power becomes 5 kw. In this case, the controller controls the battery to output the summation power of 5 kw to the electric components and the air conditioner, and controls the drive motor to output the remained power of 20 kw to make up the power gap between the engine optimal power of 75 kw and the driving power of 95 kw.

Or, when the travelling mode of the vehicle is EV mode, the controller disengages the clutch provided between the engine and the drive motor, and operates the drive motor so that the target driving power is only output from the drive motor. That is, the controller stops the operation of the engine and the electric supercharger, and calculates the summation power that sums the electric component power and the air conditioner power.

And the controller controls the drive motor to output the driving power, and controls the power to output the summation power desired for the electric component and the air conditioner.

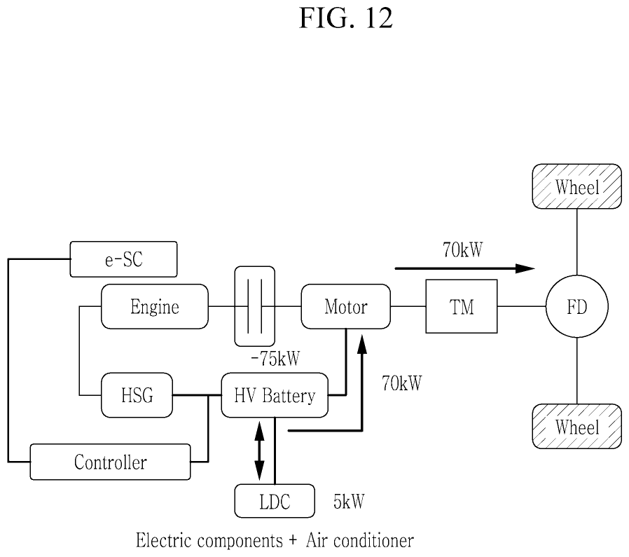

For example, referring to FIG. 12, when the driving power of the vehicle is 70 kw and the summation power of the electric component power and the air conditioner is 5 kw, the summation power of 5 kw is supplied from the battery and the driving power of 70 kw is output from the drive motor.

When the desired operation of the driver is the low load state (LTI: low tip-in) and the SOC of the battery is less than a predetermined value (it may means the low region of SOC in an exemplary form of the present disclosure), the controller calculates the target driving power based on the desired power of the driver. And the controller controls the engine to output an optimal power to be operated in an optimal efficiency point and the electric supercharger not to be operated.

The controller calculates the summation power that sums the electric component power and the air conditioner power.

In this case, since the SOC is a low state, the summation power for operating the electric component and the air conditioner uses a part of the power output from the engine. That is, the controller operates the drive motor as a generator to generate the summation power and a charging power to charger the battery by using a part of the optimal power output from the engine.

Accordingly, the power excluding the summation power and the charging power from the optimal power of the engine is output as the driving power of the vehicle.

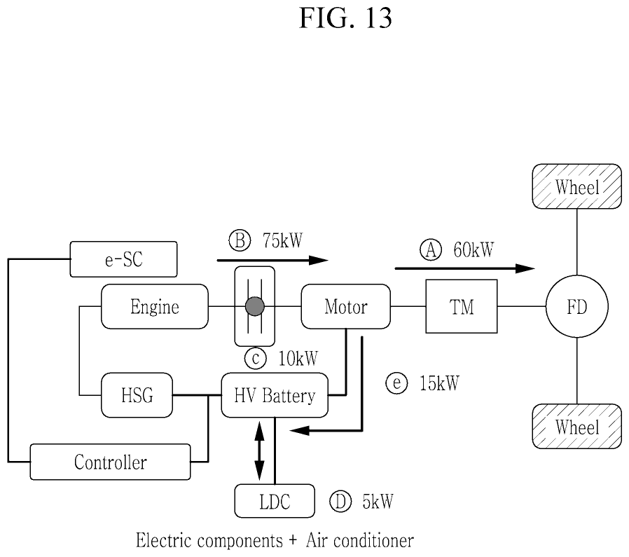

For example, referring to FIG. 13, when the optimal power output from the engine is 75 kw, the controller operates the electric supercharger so that the engine outputs the optimal power of 75 kw. Assume that the electric component power and the air conditioner power are 5 kw. Thus, the summation power becomes 5 kw. In this case, the controller operates the drive motor as a generator to generate 5 kw using the optimal power output from the engine and supplied it to the electric component and the air conditioner. And the charging power of 10 kw for charging the battery is charged in the battery. Accordingly, 60 kw, excluding the summation power of 5 kw and the charging power of 10 kw from the engine's optimal power 75 kw, is output as the driving power.

As such, the SOC of the battery is a low region, and the vehicle is in the middle load state, some of the engine's maximal power is used as electric power desired to operate the electric component and the air conditioner, and some are used to charge the battery.

As such, when the SOC of the battery is the low region and the desired power is middle load state, some of the engine's maximal power is used as electric power desired to operate the electric components and the air conditioner, and some of the engine's maximal power is charged in the battery.

### DESCRIPTION OF SYMBOLS

10: engine
11: combustion chamber
13: intake manifold
14: throttle valve
15: exhaust manifold
17: exhaust line
19: catalytic converter
21: intake line
29: air cleaner
31: electric supercharger
36: intercooler
40: HSG
50: drive motor
60: clutch
70: battery
80: transmission
90: controller
100: APS

While this present disclosure has been described in connection with what is presently considered to be practical exemplary forms, it is to be understood that the present disclosure is not limited to the disclosed forms. On the contrary, it is intended to cover various modifications and equivalent arrangements included within the spirit and scope of the present disclosure.

What is claimed is:

1. An apparatus of controlling a hybrid vehicle, the apparatus comprising:
an engine configured to generate an engine power;
a drive motor configured to generate a power to assist the engine power and selectively operate as a generator to generate electrical energy;
a clutch configured to disposed between the engine and the drive motor;
a battery configured to supply electrical energy to the drive motor or to be charged with the electrical energy generated by the drive motor;
an electric supercharger installed in an intake line through which an ambient air is supplied to a combustion chamber of the engine; and
a controller configured to:
operate the electric supercharger, and
control the engine power of the engine and the power of the drive motor based on a desired power of a driver and a state of charge (SOC) of the battery.

2. The apparatus of claim 1, wherein:
the desired power is determined based on a position of an accelerator pedal position sensor (APS) operated by the driver, and
based on the desired power, a desired operation of the hybrid vehicle is divided into a maximal high load state, a high load state, a middle load state, and a low load state.

3. The apparatus of claim 2, wherein:
when the desired operation is the maximal high load state and the SOC of the battery is greater than a predetermined value, the controller is configured to:
operate the electric supercharger to cause the engine to output an engine maximal power,
control the drive motor to output a remained power corresponding to a power gap between the engine maximal power generated by the engine and a target driving power of the hybrid vehicle which is determined based on the desired power, and
control the battery to supply the electrical energy to the drive motor, where the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner.

4. The apparatus of claim 2, wherein:
when the desired operation is the maximal high load state and the SOC of the battery is less than a predetermined value, the controller is configured to:
operate the electric supercharger to cause the engine to output an engine maximal power, and
control the drive motor to be operated as a generator to generate electrical energy using a part of the engine maximal power output from the engine, and
the generated electrical energy by the drive motor is supplied to the electric supercharger, electric components of the hybrid vehicle, and an air conditioner of the hybrid vehicle.

5. The apparatus of claim 2, wherein:
when the desired operation is the high load state and the SOC of the battery is greater than a predetermined value, the controller is configured to:
operate the electric supercharger to cause the engine to output an engine maximal power,
control the drive motor to output a remained power corresponding to a power gap between the engine maximal power generated by the engine and a target driving power of the hybrid vehicle which is determined based on the desired power, and
control the battery to supply the electrical energy to the drive motor, where the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner.

6. The apparatus of claim 2, wherein:
when the desired operation is the high load state and the SOC of the battery is less than a predetermined value, the controller is configured to:
operate the electric supercharger to cause the engine to output an engine maximal power, and
control the drive motor to be operated as a generator to generate electrical energy using a part of the engine maximal power output from the engine, and
the generated electrical energy by the drive motor is supplied to the electric supercharger, electric components, and an air conditioner of the hybrid vehicle.

7. The apparatus of claim 2, wherein:
when the desired operation is the middle load state and the SOC of the battery is greater than a predetermined value, the controller is configured to:
control the electric supercharger and the engine to output an optimal power to be operated in an optimal efficiency point, and
control the drive motor to output a remained power corresponding to a power gap between the optimal power of the engine and a target driving power of the hybrid vehicle which is determined based on the desired power, and
control the battery to supply the electrical energy to the drive motor, where the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner.

8. The apparatus of claim 2, wherein:
when the desired operation is the middle load state and the SOC of the battery is less than a predetermined value, the controller is configured to:
control the electric supercharger and the engine to output an optimal power to be operated in in an optimal efficiency point, and
control the drive motor to be operated as a generator to generate electrical energy using the optimal power output from the engine, and
the generated electrical energy by the drive motor is supplied to the electric supercharger, electric components, an air conditioner, and the battery of the hybrid vehicle.

9. The apparatus of claim 2, wherein:
when the desired operation is the low load state and the SOC of the battery is greater than a predetermined value, the controller is configured to:
control the engine to output an optimal power to be operated in an optimal efficiency point,
stop an operation of the electric supercharger,
control the drive motor to output a remained power corresponding to a power gap between the optimal power of the engine and a target driving power of the hybrid vehicle determined by the desired power, and
control the battery to supply the electrical energy to the drive motor, where the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner of the hybrid vehicle.

10. The apparatus of claim 2, wherein:
when the desired operation is the low load state and a SOC of the battery is less than a predetermined value, the controller is configured to:
control the engine to output an optimal power to be operated in an optimal efficiency point,
stop an operation of the electric supercharger, and
control the drive motor as a generator to generate electrical energy using a part of the optimal power output from the engine, and
the generated electrical energy by the drive motor is supplied to electric components, the battery, and an air conditioner of the hybrid vehicle.

11. A method of controlling a hybrid vehicle, where the hybrid vehicle includes: a drive motor and an engine, which generate a driving power for travelling the hybrid vehicle, and an electric supercharger installed in an intake line of an engine, the method comprising:
determining, by a controller, a desired power of a driver based on a pressing amount of an accelerator pedal; and
operating, by the controller, the electric supercharger and controlling an engine power output from the engine and a drive motor power output from the drive motor based on the desired power and a state of charge (SOC) of a battery.

12. The method of claim 11, wherein:
the pressing amount of the accelerator pedal is detected by an accelerator pedal position sensor (APS) disposed in the hybrid vehicle, and
a desired operation of the hybrid vehicle is determined by the controller based on the desired power and divided into a maximal high load state, a high load state, a middle load state, and a low load state.

13. The method of claim 12, further comprising:
when the desired operation is the maximal high load state and the SOC of the battery is greater than a predetermined value,
controlling, by the controller, the engine to output an engine maximal power;
operating, by the controller, the electric supercharger to cause the engine to output the engine maximal power;
controlling, by the controller, the drive motor to output a remained power corresponding to a power gap between the engine maximal power of the engine and a target driving power of the hybrid vehicle determined based on the desired power; and
controlling, by the controller, the battery to supply electrical energy to the drive motor,
wherein the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner of the hybrid vehicle.

14. The method of claim 12, further comprising:
when the desired operation is the maximal high load state and the SOC of the battery is less than a predetermined value,
controlling, by the controller, the engine to output an engine maximal power;
operating, by the controller, the electric supercharger so that the engine outputs the engine maximal power;
controlling, by the controller, the drive motor to be operated as a generator to generate electrical energy using a part of the engine maximal power output from the engine; and
supplying, by the controller, the electrical energy generated by the drive motor to the electric supercharger, electric components, and an air conditioner of the hybrid vehicle.

15. The method of claim 12, further comprising:
when the desired operation is the high load state and the SOC of the battery is greater than a predetermined value,
controlling, by the controller, the engine to output an engine maximal power;
operating, by the controller, the electric supercharger so that the engine outputs the engine maximal power; and
controlling, by the controller, the drive motor to output a remained power corresponding to a power gap between the engine maximal power of the engine and a target driving power of the hybrid vehicle which is determined based on the desired power; and
controlling, by the controller, the battery to supply electrical energy to the drive motor,
wherein the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner of the hybrid vehicle.

16. The method of claim 12, further comprising:
when the desired operation is the high load state and the SOC of the battery is less than a predetermined value,
controlling, by the controller, the engine to output an engine maximal power;
operating, by the controller, the electric supercharger so that the engine outputs the engine maximal power; and
controlling, by the controller, the drive motor to be operated as a generator to generate electrical energy corresponding to a summation power by using a part of the engine maximal power output from the engine, and
wherein the summation power is a sum of a supercharger power consumed by the electric supercharger, an electric component power consumed by electric components, and an air conditioner power consumed by an air conditioner of the hybrid vehicle.

17. The method of claim 12, further comprising:
when the desired operation is the middle load state and the SOC of the battery is greater than a predetermined value,
controlling, by the controller, the engine to output an optimal power;
operating, by the controller, the electric supercharger so that the engine outputs the optimal power;
controlling, by the controller, the drive motor to output a remained power corresponding to a power gap between the optimal power of the engine and a target driving power of the hybrid vehicle which is determined based on the desired power; and
controlling, by the controller, the battery to supply electrical energy to the drive motor, wherein the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner of the hybrid vehicle.

18. The method of claim 12, further comprising:
when the desired operation is the middle load state and the SOC of the battery is less than a predetermined value,
controlling, by the controller, the engine to output an optimal power;
operating, by the controller, the electric supercharger so that the engine outputs the optimal power; and
controlling, by the controller, the drive motor to be operated as a generator that generates a summation power and a charging power by using the optimal power output from the engine,
wherein the summation power is a sum of a supercharger power consumed by the electric supercharger, an electric component power consumed by electric components, and an air conditioner power consumed by an air conditioner, and the charging power is a power for charging the battery.

19. The method of claim 12, further comprising:
when the desired operation is the low load state and the SOC of the battery is greater than a predetermined value,
controlling, by the controller, the engine to output an optimal power;
stopping, by the controller, an operation of the electric supercharger;
controlling, by the controller, the drive motor to output a remained power corresponding to a power gap between the optimal power of the engine and a target driving power of the hybrid vehicle which is determined based on the desired power; and
controlling, by the controller, the battery to supply electrical energy to the drive motor,
wherein the supplied electrical energy to the drive motor is calculated by subtracting, from a battery power determined by the SOC of the battery, a sum of a supercharger power consumed by the electric supercharger, an electric component power consumed by electric components, and an air conditioner power consumed by an air conditioner of the hybrid vehicle.

20. The method of claim 12, further comprising:
when the desired operation is the low load state and the SOC of the battery is less than a predetermined value,
controlling, by the controller, the engine to output an optimal power;
stopping, by the controller, an operation of the electric supercharger; and
controlling, by the controller, the drive motor to be operated as a generator to generate a summation power and a charging power to charger the battery by using a part of the optimal power output from the engine,
wherein the summation power is a power that sums an electric component power consumed by electric components and an air conditioner power consumed by an air conditioner of the hybrid vehicle.
